(19) United States
(12) Patent Application Publication
(10) Pub. No.: US 2018/0081880 A1
(43) Pub. Date: Mar. 22, 2018

(54) Method And Apparatus For Ranking Electronic Information By Similarity Association

(71) Applicants: Alcatel-Lucent Canada Inc., Ottawa (CA); Alcatel-Lucent USA Inc., Murray Hill, NJ (US)

(72) Inventors: William S. Kennedy, Chelsea (CA); Iraj Saniee, New Providence, NJ (US); Christopher A. White, Neshanic Station, NJ (US); Yihao Lisa Zhang, Chatham, NJ (US); Gordon T. Wilfong, Florham Park, NJ (US); Chun-Nam Yu, Jersey City, NJ (US); Nachi K. Nithi, Wayne, NJ (US)

(73) Assignees: Alcatel-Lucent Canada Inc., Ottawa (CA); Alcatel-Lucent USA Inc., Murray Hill, NJ (US)

(21) Appl. No.: 15/267,405

(22) Filed: Sep. 16, 2016

(51) Int. Cl. G06F 17/30; G06N 99/00

(52) U.S. Cl. CPC G06F 17/3053; G06N 99/005; G06F 17/30958

(57) ABSTRACT

Systems and methods are provided for ranking electronic information based on determined similarities. In one aspect a set of unique features are determined from a collection of electronic objects. A graph is constructed in which electronic object are represented as object nodes and determined features are represented as feature nodes. The object nodes are interconnected by a weighted edge to at least one feature node. Scores for the object nodes and the feature nodes are computed using a determined set of anchor nodes and a determined weighted adjacency matrix. The object nodes and the feature nodes of the graph are ranked and displayed based on the computed scores. In one aspect, the scores and the ranks for the object nodes and the feature nodes are dynamically updated and displayed based on user preferences.

### TECHNICAL FIELD

The present disclosure is directed towards processing systems, and in particular, to computer-implemented systems and methods for processing, finding, and ranking textual and non-textual information stored in electronic format.

### BACKGROUND

Networking technologies have enabled access to a vast amount of online information. With the proliferation of networked consumer devices such as smart-phones, tablets, etc., users are now able to access information at virtually anytime and from any location.

Search engines enable users to search for information over a network such as the Internet. A user enters one or more keywords or search terms into a web page of a web browser that serves as an interface to a search engine. The search engine identifies resources that are deemed to match the keywords and displays the results in a webpage to the user.

A user typically selects and enters topical keywords into the web-browser interface to the search engine. The search engine performs a query on one or more data repositories based on the keywords received from the user. Since such searches often result in thousands or millions of hits or matches, most search engines typically rank the results and a short list of the best results are displayed in a webpage to the user. The results webpage displayed to the user typically includes hyperlinks to the matching results in one or more webpages along with a brief textual description.

### BRIEF SUMMARY

In various aspects, systems and methods for are provided for processing, ranking, and displaying electronic information by similarity. The present systems and methods are applicable to search engines configured to search and display results to a user.

In one aspect, a set of unique features are determined from a collection of electronic objects. A graph is constructed in which each electronic object is represented as an object node and each unique feature is represented as a feature node. Each object node is interconnected by a weighted edge to at least one feature node in the graph. A weighted adjacency matrix is constructed using the graph and a anchor vector is determined to represent a set of anchor nodes in the graph. Scores for all of the object nodes and the feature nodes of the graph are computed using the vector representing the set of anchor nodes and the weighted adjacency matrix.

In one aspect, the object nodes and the feature nodes of the graph are ranked based on the computed scores, and the ranked object nodes and feature nodes of the graph are displayed on a display device.

In one aspect, the vector representing the set of anchor nodes in the graph is updated based on user input indicating selection of the one or more of the displayed nodes by the user. The scores for the object nodes and the feature nodes of the graph are then updated (recomputed) using the updated vector and the weighted adjacency matrix, and ranks of the object nodes and the feature nodes are also updated based on the updated scores. The display of the ranked object nodes and feature nodes on the display device is updated based on the updated ranks.

In one aspect, scores for the object nodes and the feature nodes of the graph are computed by iteratively applying the vector representing the set of anchor nodes and the weighted adjacency matrix to a Personalized Page Rank algorithm. In one aspect, the scores for the object nodes and the feature nodes of the graph are computed by aggregating scores resulting from each iteration of the Personalized Page Rank algorithm.

In one aspect, the set of anchor nodes in the graph are determined based on user input. In another aspect, the set of anchor nodes in the graph are determined by selecting each object node and each feature node of the graph as an anchor node in the set of anchor nodes.

In one aspect, at least one determined unique feature in the set of unique features represents textual information in the collection of electronic objects. In another aspect, at least one determined unique feature in the set of unique features represents non-textual information in the collection of electronic objects.

In one aspect, a machine learning algorithm is applied to the collection of electronic objects to determine at least one unique feature in the set of unique features using the machine learning algorithm.

### BRIEF DESCRIPTION OF THE DRAWINGS

FIG. 1 illustrates an example embodiment of a computer-implemented process for processing, searching, ranking, and displaying electronic information in accordance with various aspects of the disclosure.

FIG. 2 illustrates a simplified example of a graph constructed in accordance with various aspects of the disclosure.

FIG. 3 illustrates a general example of an arbitrary graph in accordance with an aspect of the disclosure.

FIG. 4 illustrates an example of an adjacency matrix constructed based on the graph illustrated in FIG. 3.

FIG. 5 illustrates an example of a row-normalized weighted adjacency matrix constructed based on the graph illustrated in FIG. 3.

FIG. 6 illustrates a Graphical User Interface in accordance with various aspects of the disclosure.

FIG. 7 illustrates a block diagram of an example apparatus for implementing various aspects of the disclosure.

### DETAILED DESCRIPTION

Various aspects of the disclosure are described below with reference to the accompanying drawings, in which like numbers refer to like elements throughout the description of the figures. The description and drawings merely illustrate the principles of the disclosure. It will be appreciated that those skilled in the art will be able to devise various arrangements that, although not explicitly described or shown herein, embody the principles and are included within spirit and scope of the disclosure.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

A typical search executed by a search engine often produces thousands upon thousands of matching results. In order to make the results manageable, search engines typically rank the matching results and display a subset of the ranked results in one more webpages in a descending order of rank.

One well-known technique for ranking webpages is the PageRank algorithm, which represents importance of a webpage as a determined stationary probability of visiting that webpage. PageRank is based on the principle that there will be a greater number of hyperlinks to more important webpages than to less important webpages. Thus, the importance of a webpage is determined based on the number, and determined importance, of other webpages that link to that webpage. The PageRank algorithm is implemented as random surfer model of visiting webpages using graph theory in which vertices (or nodes) of a graph represent web pages and edges or links interconnecting the nodes of the graph represent hyperlinks from one webpage to another. Because of their computational expense, conventional search engines such as PageRank are one-time computation that are performed prior to any actual search or query. Data items are first universally ranked and then indexed to match against search term queries. As long as the underlying graph is essentially unchanged, no recomputation is performed, particularly when a user provides keywords to the search engine for a search.

Although conventional search engines and algorithms are effective and useful, there is much room for improvement in the area of identifying and displaying results that are relevant to the user. For example, despite the sophistication and optimization of search engines, typical searches can frequently result in much information being displayed that is not that relevant to the user. Sometimes search results do not produce useful results at all or do not include results that may in fact be relevant to a user. In typical scenarios, the user may have to conduct multiple searches in order to guess the right set of keywords that produces results that produce a set of meaningful results even if the results also include items not of interest to the user. The focus of the search engines on matching particular search keywords with predetermined set of data can suppress or exclude information that may be conceptually of more interest to the user. It may take a user considerable time to find the keywords that provide meaningful results while at the same time do not overwhelm the user with a large amount of information that is not useful or of interest to the user.

Systems and methods are described herein for processing, ranking, and displaying electronic information. The systems and methods are applicable to computationally searching and finding relevant information from any electronic information objects that are accessible in a computer-readable format and in some embodiments are particularly applicable in the context of searches conducted over a network such as the Internet.

As will be apparent from the following description, the systems and methods disclosed herein can be characterized as having two phases, a preprocessing phase and an interactive phase. The preprocessing phase includes processing a set of electronic objects, determining a set of common categories, and determining a set of unique features that are included in or derived from information in the objects. The preprocessing phase further includes constructing a graph which includes nodes that represent the objects and their features interconnected by weighted edges, and (optionally) computing a default score and ranking of the interconnected nodes of the graph for display to a user. The interactive phase includes receiving user input (e.g., from a user's device over a network) that indicates a user's particular preference of certain objects or features, and using the user input dynamically compute or (recompute) the score and rank of the nodes representing the objects and features for display to the user on, for example, a user's device. As will be apparent from the disclosure, the interactive phase includes a universal ranking (that is ranking and scoring all objects in the corpus) in the context of the topics of interest to the user. Therefore unlike conventional query systems, each query generates its customized score for all objects in the corpus that are used to rank order the results.

As used herein, the term object refers to an electronic entity in which information (either textual or non-textual) is stored in a computer-readable format. Some example of electronic objects (also sometimes referred to as objects) include documents, publications, articles, web-pages, images, video, audio, databases, tables, directories, files, user data, or any other types of computer-readable data structures that include information stored in an electronic format. The type of information and the source of the information of the electronic objects may vary. In some embodiments, the source of the information may be data repository, such as one or more pre-configured databases of electronic publications, articles, webpages, images, audio, multi-media files etc. In some embodiments the source of the information may be more dynamic. In one embodiment the source of information for the electronic objects may be query results that are obtained from a search using a conventional search engine. For example, a user may perform a conventional search using keywords in a conventional search engine such Google's or Microsoft's search engines. The set of data resulting from a search conducted via a conventional search engine may be the initial source of information that is stored in the electronic objects (e.g., as web-pages) that is processed further as described herein below. In another embodiment, the source of the information of the electronic objects may be the sensor data that is received from a number and different types of electronic sensors. The output of the sensors may be environmental or other data such as temperature, pressure, location, alarm, etc., and may also be multimedia data such as audio or video data. The data from the sensors may be received and stored in a data repository as electronic objects and processed in accordance with the aspects described herein. In yet another embodiment the source of the data of the electronic objects described herein may be user data. Some examples of such user data include a user's profile, contact data, calendar data, chat message data, email data, browsing data, social network data, or other types of data (e.g., user files) that are stored on a user's device to which access is allowed by a user for further processing as described below.

The term feature as used in the present disclosure refers to particular information that is either determined to be part of information stored in an electronic object or is derived from information included in the object. The determined features may be textual or non-textual. One example of determining textual features includes determining the text or words that are found an electronic document, publication, webpage etc. Another example of determining textual features includes determining text or words from metadata associated with an electronic object. In general, any textual information included in an electronic object may be a determined feature in accordance with the aspects described herein below. Textual features may also be derived from non-textual information in an electronic object. For example, where an electronic object is an image (or a video) determining textual features from the image or video may include processing and recognizing non-textual content of the image or video. For example, a picture of a dog may be processed using image processing or machine learning techniques and textual features such as “dog”, its breed, its size, its color, etc. may be derived and identified from the picture. Similarly, non-textual audio data may be analyzed using audio, speech-to-text, or machine learning techniques and recognized words or other textual information derived from the audio may be determined as a feature of the image or video in accordance with the disclosure. Similarly, non-textual sensor data output by one or more sensors may be analyzed and characterized by one or more textual features such as “door open”, “fire”, “emergency”, temperature or pressure value, etc.

The determined features of an electronic object may also be non-textual. For example, returning to the example of an image or video, the features that are determined from the image or video may be a set of pixels in the image or the video that are recognized using object recognition, pattern recognition, or machine learning techniques. Alternatively, or in addition, the determined non-textual features may be a set of object or pattern recognition vectors or matrices that are determined based on the contents of the image or video. Non-textual features determined by analyzing an audio object may include a portion of musical or vocal tracks recognized within the audio using audio processing or machine learning techniques. Non-textual features determined from analyzing sensor output data may be all or part of sensor data associated with one or more recognized events captured by the sensors during one or more period of times.

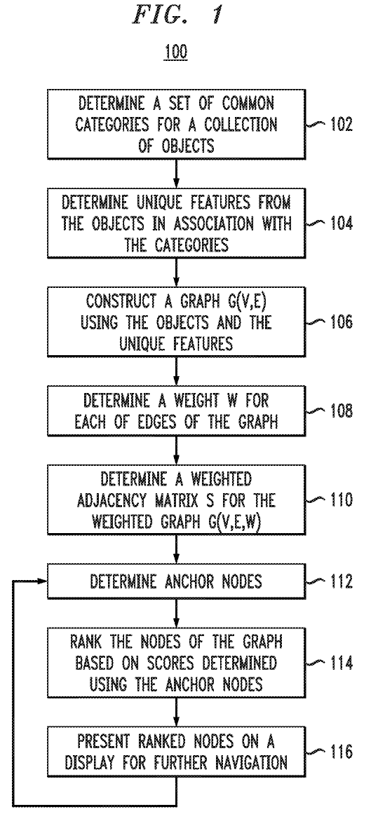

FIG. 1 illustrates an example computer-implemented process 100 for processing, ranking, and displaying electronic information using a processor. In some embodiments, process 100 may be implemented as part of a search engine executed by a processor on a service provider's back-end server device. In other embodiments, the process 100 may be implemented using a processor external to the search engine. In some embodiments the process described herein may be implemented and executed by a processor on a user's computing device. Although examples in various steps of process 100 are described below in terms of textual objects and features for simplicity and convenience, it will be understood that the process described herein is equally applicable to non-textual objects and non-textual features described above.

Although process 100 is described in sequential steps or operations, it will be appreciated that some of the operations may be performed in parallel, concurrently or simultaneously. In addition, the order of the operations may be re-arranged. A process may be terminated when its operations are completed or may continue from the start or an intermediate point as appropriate. The process may also have additional steps not included in the figure. One or more steps of the process 100 may correspond to and be implemented as a method, function, procedure, subroutine, subprogram, program etc. that is executed by a processor.

In step 102, the process 100 includes processing a collection of electronic objects and determining a set of common categories that are applicable to the objects. By way of a simplified example, assume that the collection or set of electronic objects is a set of electronic publications (e.g., published white-papers) that are stored in a computer-readable format in electronic data repository accessible to the processor implementing process 100. A set of categories that are determined by the processor as being commonly applicable to the set of publications may include categories such as Author, Title, Words, Date of Publication, Geographical Location, etc. In general, the determined set of common categories may include any category that represents a common attribute or aspect of the objects being processed.

The set of common categories (also referenced herein as “categories”, may be determined automatically or manually. For example, in one embodiment the categories may be determined automatically based on metadata associated with each of the objects. In another embodiment, the categories may be determined automatically based on knowledge of the type (or structure) of the objects. For example, if the objects are known to be publications, then the set of common categories for publication type objects may include predetermined categories such as Author, Title, Words, Date of Publication, Geographical Location, etc. As another example, if the objects being processed are webpages, then the set of common categories may include Title, URL (Uniform Resource Location), Date, Company, Words, etc. In some embodiments, the set of common categories may also be allocated manually based on human input. In some embodiments, the set of common categories may be determined via supervised or unsupervised machine learning techniques.

In step 104, the process 100 includes determining a set of unique features from the objects for the common categories. The set of unique features that are allocated to each of the categories are determined based on information contained in the objects. Returning to the simplified example where the set of objects is a set of publications, the set of unique features allocated to the common category Author may include a list of the unique names of the authors that are found in the publications. Thus, the processor in this step may parse the textual information in each of the publications and extract unique names such that the allocated unique features of category Authors is a list of unique author names found in the publications. The set of unique features allocated to the common category Dates may include a list of the unique dates of publication that are determined from processing the publications. The set of unique features allocated to the common category Location may include a list of the unique geographical locations associated with the publications (e.g., geographical location of the publication). The set of unique features allocated to the common category Words may include a list of all the unique words that are found in the publications. The processor may similarly continue to process the objects to extract the unique features allocated to each of other determined common categories. In some embodiments, the set of unique features may also be allocated manually based on human input. In some embodiments, the set of unique features may be determined via supervised or unsupervised machine learning techniques.

It is repeated that the example set of electronic objects and the example set of determined features are assumed to be textual only for aiding the understanding of the principles of the disclosure. As noted above, in practice the set of electronic documents and the features that are determined or derived from the electronic documents may include textual information, non-textual information or a combination of textual or non-textual information without departing from the principles of the systems and methods described herein. Furthermore, in one embodiment a feature vector may be determined for one or more electronic objects using a machine learning engine which assigns a set of compact numerical values representing one or more attributes to each object based on a training set of data. Feature vectors of length 200-300 tuples and 1000 tuples have been found to provide good description of textual and image features, and the result of the machine learning output may be used as the features of the graph as described herein.

In step 106, the process 100 includes constructing a graph G=(V,E) where V represents each of the N number of the vertices or nodes of the graph and E represents the edges interconnecting one or more of the N nodes of the graph. The graph G is constructed such that each electronic object is represented as a node of the graph that is connected with an edge to a node that represents a determined feature that is found in (or derived from) information in the object. In other words, graph G includes a set of N nodes where each object in the collection of objects and each determined unique feature is represented by a respective node in the graph and, for each object that includes a particular feature there is an edge that interconnects the respective node representing that object with the respective node that represents that feature.

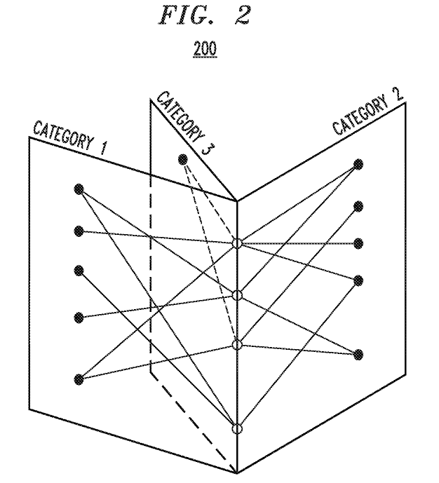

FIG. 2 shows an illustration of a graph 200 in accordance with step 106. As seen in FIG. 2, graph 200 includes objects nodes (depicted as hollow circles) that are interconnected with unique feature nodes (depicted as filled in circles) that were found or derived from each of the objects with an interconnecting edge (depicted by a connecting line). Continuing the simplified example above, the object nodes may represent publications. Categories 1, 2, and 3 may represent the determined common categories of the publications. For example, Category 1 may be Words, Category 2 may be Publication Date, and Category 3 may be Authors. Each of the feature nodes illustrated in the Categories may represent unique textual information extracted or determined in the objects. So, for example, the feature nodes in the Words category (Category 1) may represent all of the unique words that are found in the publications (e.g., the unique textual words in the publications). Similarly, the feature nodes in the Publication Date category (Category 2) may represent all of the unique publication dates of the publications. Lastly, the feature nodes in the Authors category may represent all of the unique author names of the publications. An edge interconnecting an object node to a feature node represents that that particular feature was found in that object. So for example, if a unique author name “John Doe 1” is an author of two of the publications, there would be an edge interconnecting each of the two object nodes representing those publications to the feature in Category 3 that represent the unique name “John Doe 1”. Similarly, and by way of another example, if the word “Wireless” is found in two of the publications, then this would be represented in graph 200 by two edges from two object nodes representing those respective publications to the feature node in Category 1 that represents the unique word “Wireless”. As will be apparent from above, if a particular unique feature (e.g., a word found in a first publication) is not found in any of the words of a second publication, there would be no edge interconnecting the feature node representing that word to the object node that represents the second publication.

Although only a few object nodes, feature nodes, and edges are depicted in FIG. 2, it will be understood that in practice graph 200 may include many (thousands upon thousands) of object nodes and feature nodes that are interconnected with many more edges. Similarly, although only three categories are illustrated, in practice there may be fewer or greater number of categories as applicable or desired. In this regard, graph 200 may also be understood as a collection of bipartite sub-graphs corresponding to each determined common category. Furthermore, it will also be understood that in although graph 200 is illustrated graphically in FIG. 2 for explanation purposes, in an exemplary implementation the information depicted in graph 200 may be stored by the processor in, for example, a local memory accessible to the processor and in the form of one or more computer-readable data structures (e.g., vectors or matrices) such that processor or computing device may rapidly access and process the information illustrated in FIG. 2. It is noted that the graph illustrated in FIG. 2 is one example and that in other embodiments other types of graphs may be constructed and processed as described herein. In some embodiments, any arbitrary graph consisting of nodes and edges could be used the underlying structure for similarity score computation and the resulting ranking for a given set of objects (anchors). In this general setting the rules for assigning weights to the interconnecting edges of such graph may be different.

In step 108, the process 100 includes determining a weight W for each of edges of the constructed graph G(V,E) that represents a strength of a determined feature found in or derived from an object. The strength of a feature within the object in the weighted graph G(V,E,W), and hence the weight allocated to the edge interconnecting the feature and the object, may be determined in a variety of ways. In one embodiment, the strength of a feature within an object may be determined based on a frequency with which the feature occurs in the object. For example, if a certain feature (e.g., the unique word “Wireless”) appears with greater frequency than another feature (e.g., the unique word “Wireline”) in a publication, the edge interconnecting the node representing the object with the node representing the feature “Wireless” may be allocated a proportionally greater weight than the edge interconnecting that object node with the feature node representing the word “Wireline”. In one embodiment, the frequency (or number of occurrences) of a feature in an object may be taken as the strength or weight of an edge between that object and that feature. If the word “Wireless” appears 15 times in an object, the strength of the edge interconnecting the object to the feature “Wireless” in graph 200 may be allocated a weight of 15. If the word “Wireline” appears 2 times in an object, the strength of the edge interconnecting the object to the feature “Wireline” in graph 200 may be allocated a weight of 2. In an exemplary implementation, the determined strengths may be stored by the processor in memory as, for example, a 1D (Dimensional) feature vector of associated with the object, where each location (or index) of the feature vector may be associated with a unique feature found or derived from the object (e.g., “Wireless”, “Wireline”) and each entry at the location or index in the feature vector may represent the strength of that feature in that object (e.g., Feature Vector of object Node i=[ . . . ,15, 2, . . . ]).

In another embodiment, the strength of a feature may be determined based on an emphasis placed on that feature in the object or based on the determined location of the feature in that object (e.g., title, headline, etc.). In some embodiments the strength of the feature may be determined manually, such as by an individual that is a subject matter expert. In some embodiments, the strength of a feature may be determined, or adjusted, based on grammatical features of a language. For example, certain grammatically used words appear that appear with high frequency may include conjunctions, disjunctions, articles, etc. Since such words (the, and, or, if, but etc.) may typically be understood as being used for grammatical expression rather being an intrinsic or independent attribute of the object, the strength of such features may be determined as being very low within the object, and the edge interconnecting such a feature to that object may similarly be given a very low or perhaps even a null weight.

In some exemplary embodiments, the weights of all edges from a given object to the features in that object may be normalized between 0 and 1 such that the weights of the edges interconnecting the object to the features in that object add or aggregate to one.

In step 110, the process 100 includes determining a weighted adjacency matrix S representing the weighted graph G(V,E,W) of step 108. Where there is an edge connection between two nodes, a positive number is entered in the appropriate location in adjacency matrix A. Whenever there is an edge (link) between two objects i, j, the adjacency matrix will have a positive entry Aᵢⱼ>0 representing the determined strength or weight of the edge; where there is no edge (link) between two objects, the adjacency matrix will have a zero entry.

FIGS. 3-5 illustrate a general example of constructing a weighted adjacency matrix for an arbitrary graph of nodes interconnected with edges. FIG. 3 illustrates a graph 300 having four nodes 1-4 (N=4) that are interconnected by edges as shown in the figure.

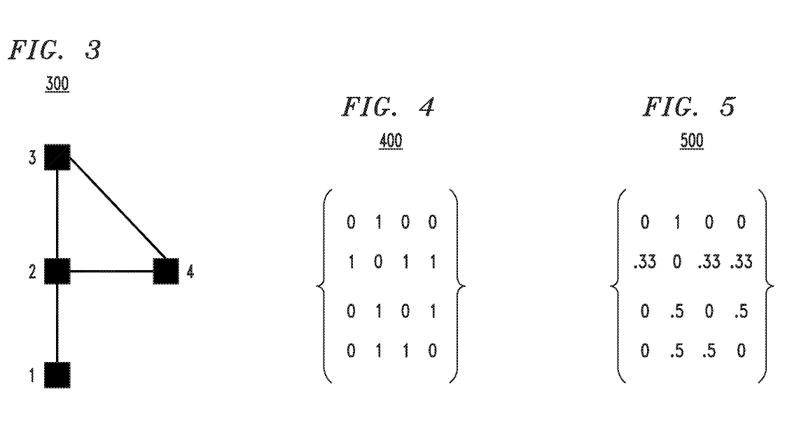

FIG. 4 illustrates an example of a basic (4×4) N×N adjacency matrix constructed for the graph 300. Each row i (i=1 . . . N) of the adjacency matrix 400 represents a particular node i in graph 300. Similarly, each column j (j=1 . . . N) columns in adjacency matrix 400 represents a particular node j in graph 300. Whenever there is an edge (link) between two nodes i, j, the adjacency matrix will have a positive entry Aᵢⱼ=1 representing the edge; where there is no edge (link) between two nodes, the adjacency matrix will have a zero entry. All entries where i=j are populated with zeros since a node is not interconnected to itself by an edge.

FIG. 5 illustrates an example of a row-normalized N×N (4×4) weighted adjacency matrix 500 (or S) constructed for the graph 300. As with the adjacency matrix of FIG. 4, each row i (i=1 . . . N) of the weighted adjacency matrix 500 represents the ith node in graph 300. Similarly, each column j (j=1 . . . N) columns in adjacency matrix 500 represents a particular node j in graph 300. Weighted adjacency matrix 500 differs from the basic adjacency matrix 400 in that whenever there is an edge (link) between two nodes i, j, the adjacency matrix will have a positive entry Aᵢⱼ>0 that now represents now only that there is an edge between the nodes i,j, but also the determined (and row-normalized in this example) weight or strength of the edge; as before, where there is no edge (link) between two nodes, the weighted adjacency matrix will have a zero entry. Again, all entries where i=j are populated with zeros since a node is not interconnected to itself by an edge.

In step 112, the process 100 includes determining a set of one or more anchor nodes where the anchor nodes represents particular object nodes and/or feature nodes of the graph 200 that are deemed to be of interest to a user (e.g., in one embodiment the anchor nodes may be determined based on user input as described further below). In an exemplary implementation, the anchor nodes may be represented using a N×1 anchor vector u where each location or index i (i=1 . . . N) of vector u represents a corresponding i'th node of the N nodes in the graph constructed in step 106 and a positive entry uᵢ>0 (e.g., uᵢ=1) in the vector u represents a selection of that node in the graph as an anchor node, whereas a null value uᵢ=0 indicates a non-selection of that node as an anchor node. In some embodiments, a first selected anchor node may have a higher positive entry in vector u than a second selected anchor node in vector u, representing user's preference to select both nodes as anchor nodes but also indicating that the first selected anchor node is deemed more important (or higher priority) by the user than the second selected anchor node. In some embodiments, the values of vector u may be normalized between 0 and 1.

In step 114, the process 100 includes ranking the nodes of the graph 200 from highest to lowest based on determined scores of the nodes, where the scores of the nodes are determined based on the selected anchor nodes. The result of step 114 is ranking of all nodes of the graph from highest to lowest based on their scores where the relatively higher ranked nodes are deemed to be more similar or relevant to the anchor nodes that were selected as being nodes that are of interest to the user than relatively lower ranked nodes. In other words, the higher the rank of a scored object or a scored feature node, the greater its similarity or relevance to the anchor nodes and thus the greater the potential relevance to the user.

In one embodiment, the scores of the nodes are determined by generating an approximation solution using the Personalization Page Rank (PPR) algorithm. The PPR is based on a modification to the well known PageRank algorithm by taking a user's preferences into account.

In accordance with this embodiment, in step 114 a processor may be configured to determine PPR by iteratively solving v₍ₘ₎^{T}=v₍ₘ₋₁₎^{T}[(1−a)S+a 1·u^{T}] where 1 is a column vector of 1's of length N (N×1 vector of 1's), u is a N×1 normalized vector that represents the selected anchored nodes that are deemed to be of interest to a user (step 112), S is the determined N×N row-normalized weighted adjacency matrix (step 110) and a is a predetermined constant or fixed number between (0,1) to ensure stability of the solution as well as achieve a level of personalization, v₍ₘ₋₁₎ is a N×1 score vector of all nodes in the graph at iteration m−1, and v₍ₘ₎ is a N×1 score vector of all nodes in the graph at iteration m. To start, v₍ₘ₌₀₎ may be populated with zero entries. Thus at a given iteration m, v(m) gives the similarity score of each node of the graph to the anchored nodes represented by the anchor vector u.

Though the PPR may be iteratively computed with any desired number of iterations, where generally the greater the number of iterations the better the approximate solution, it has been found that three to five iterations in combination with the steps of the process 100 described herein give sufficiently good results in identifying nodes of the graphs that may be deemed to be relatively more closely related to the selected anchor nodes. Thus, in one exemplary embodiment the processor may iteratively compute v₍₁₎, v₍₂₎ and v₍₃₎ and rank the scores of the nodes generated in last iteration v₍₃₎ such that nodes having higher scores are ranked relatively higher than other nodes having a lower score (and the higher ranked nodes are deemed to be more relevant to the selected anchor terms and potentially more of interest to the user than the lower ranked nodes). In another embodiment, the processor may also iteratively compute v₍₄₎ and v₍₅₎ and rank the rank the scores of the nodes generated in last iteration v(₅) such that nodes having higher scores in the last or 5^{th} iteration are ranked relatively higher than other nodes having a lower score. In yet another embodiment, the processor may iteratively compute a predetermined or desired number of iterations (e.g., 3 or 5), and furthermore aggregate the scores after each iteration before ranking the scores from highest to lowest. It has been found in some cases that such aggregation of the scores after each iteration can provide better ranking of nodes of the graphs that are similar to the selected anchor nodes.

It will be understood that steps of the process 100 described above allow use of other algorithms and modifications to determine ranking and scoring of the nodes of the graph 200 to determined nodes that are most similar to the selected anchor nodes in accordance with process. Thus, in other embodiments different techniques may be used to rank the nodes based on the selected anchored nodes. To provide but one such example, in an alternative embodiment the processor may determine the ranked scores of the nodes by averaging the approximation solutions, v(1), v(2), . . . , v(m) determined above by a cumulative personalized page-rank (CPPR) vector w₍ₘ₎ where w₍ₘ₎=(v₍₀₎+v₍₁₎+v₍₂₎+ . . . +v₍ₘ₎)/m. It has been found that this cumulative score specially when combined with high values of the scalar a and relatively smaller iteration number m can provide a good proxy for binary or Boolean matching as in a standard database query. In some embodiments, w₍ₘ₎ may be solved in parallel on distributed platforms or even on specialized microchips to speed up the computation.

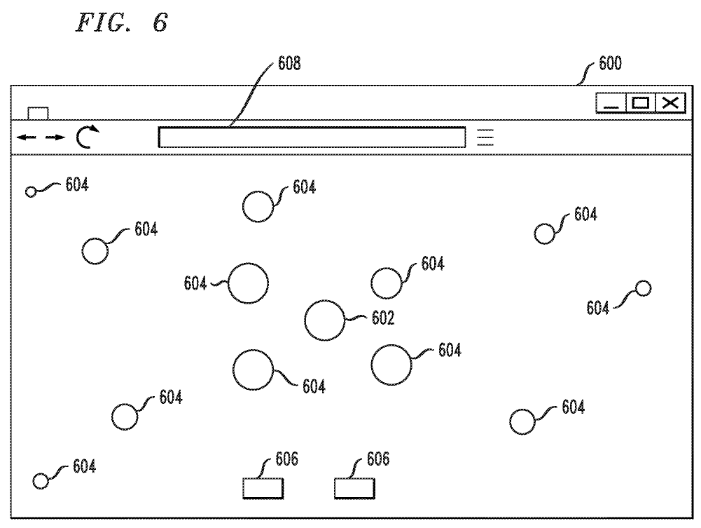

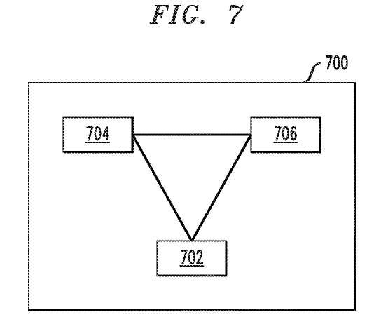

In step 116 the process 100 includes presenting the ranked nodes on a display (e.g., of a user device such as a laptop, computer, smartphone, tablet, smart-tv., etc.) for further navigation or selection by the user. Although in some embodiments all of the nodes of graph 100 could be displayed in order of their relative ranking, it may not be practical do so where there are a very large number of nodes. Furthermore, even if the number of nodes is manageable, the user may not want to see nodes that are ranked very low relative to other much higher ranked nodes. Thus, in one exemplary embodiment, in step 116 the process 100 may include selecting and displaying a subset of the highest ranked X number of nodes to a user, where all other nodes that are ranked lower are not shown on the display. In one embodiment, the highest ranked nodes may be displayed as a ranked list (e.g., in descending rank order) for further navigation by the user (along with information regarding the selected anchor nodes). However, in an exemplary embodiment described below, the highest ranked nodes may be displayed more graphically as shown in FIG. 6 to visually assist the user in quickly identifying the nodes that are most relevant to the anchor nodes that are of interest to the user. It will be understood that the GUI 600 is just one example and many modifications will be apparent without departing from the principles of the disclosure

In FIG. 6, each of the bubbles displayed in GUI 600 represents a node of the graph 200. More particularly, bubble 602 represents the set of nodes in graph 200 that were selected as the anchor nodes in step 112 of process 100. Furthermore, bubbles 604 represent ranked nodes of the graph based on the determined scores of the nodes of the graph 200 using the set of anchored nodes (step 114). Each of the bubbles may be associated with a label that is descriptive of the node or nodes that the bubble represents. The associated labels may be displayed to the user as text within the bubbles or the label may be displayed to the user when the user moves a mouse pointer over the bubble. The bubbles 604 closest to the anchor nodes 602 represent the relatively higher ranked nodes of graph 200, while the bubbles 604 that are relatively further away from the anchored nodes represent relatively lower ranked nodes of graph 200. The relative ranking of the bubbles may also be indicated based on size, where larger sized bubbles 604 may represent higher ranked nodes than smaller sized bubbles 604. In one embodiment, for example, the size of the bubbles and/or the distance from the anchor nodes may be determined by the score value of v(m) or w(m) for that node.

Many different types of visual cues (color, size, shape, shading, font, shadow, text, etc.) may be shown in GUI 600 to assist the user in navigating the information displayed to the user. For example, in various embodiments bubbles representing object nodes may be displayed differently than bubbles representing feature nodes. Furthermore, the bubbles representing features in different categories may be displayed differently so that the user may quickly identified ranked nodes belonging to a particular category. The user may use a mouse, keyboard, or touch-screen to zoom in, zoom out, crop, or resize the information displayed GUI 600, including request display of a greater or fewer number of bubbles in GUI 600.

A mouse click or a tap on a touchscreen by the user on a bubble may be interpreted as a request for information about a feature or object node represented by the bubble. For example, a double mouse click or a double tap on a touchscreen display on an object node may be interpreted as a request to retrieve the electronic object from the data repository where it is being stored. Where the electronic object is a document, publication, web-page etc., a double mouse click or tap may result in retrieval and transmission of the document, publication, web-page etc. from, for example, a server device to the user's device, where it may be automatically opened and presented to the user in the GUI 600 or via a third-party application. Where the double clicked or tapped object node includes non-textual information such as an image, audio, video etc. such content may be automatically transmitted and appropriately displayed or played for the user in the GUI 600 or via a third-party application. A double mouse click or tap on a feature node may be interpreted as a request for listing of electronic objects that include that feature. A further double click or tap on one of the listed electronic objects that includes that feature may be interpreted as a request for the content of the corresponding electronic object.

A single mouse click or a touch screen tap on a displayed bubble representing an object or feature node may be determined as an indication of the user's selection of the corresponding object or feature nodes as an anchor node (and thus a search term or query of interest to the user). Multiple object and feature nodes may be selected as anchor nodes by mouse clicks or taps on corresponding bubbles in GUI 600. The user may also click or tap on the anchor node bubble 602 to remove one, some, or all of currently selected anchor nodes.

When the user action in GUI 600 indicates addition, removal or modification of the anchor nodes, process 100 may return and dynamically and in real time may re-execute steps 112-116 to update the displayed results corresponding to the user's selections or preferences regarding the anchor nodes. This would include dynamically updating the determined set of one or more anchor nodes and the anchor vector u in step 112 based on the user's indicated preference for one or more displayed nodes, and also include dynamically updating the ranking of all of the nodes of the graph 200 from highest to lowest by updating the scores of all of the nodes of the graph based on the updated anchor vector u in step 114. In step 116, the updated ranked nodes would then be displayed to the user on the display. The In this manner, the user may be provided with the ability to indicate the user's preferences and dynamically manipulate the ranked information that is displayed to the user to further refine the ranking of the nodes of graph 200 based on user preferences or interest.

The initial selection of the anchor nodes (i.e., step 112) that are used to rank the nodes may be determined in a number of ways. In one aspect, the user may be presented with a simplified GUI 600 that includes the text box 608. The user may enter one or more keywords into text box 608 as search terms or query of interest to the user. The keywords entered by the user may be used in step 112 of process 100 to select the corresponding object and feature nodes as anchor nodes, and the process may then score and rank the nodes of the graph 200 and display the results to the user in GUI 600 as described in steps 114 and 116 respectively.

The anchor nodes may initially be also set automatically. For example, in one embodiment each of the object and feature nodes of graph 200 may be uniformly selected as an anchor node in step 112. The nodes of the graphs may then be scored, ranked and displayed to the user as described in step 114 and 116 respectively as a default universal rank. The results displayed in this embodiment would rank the nodes based on no user personalization and as a uniform and equal selection of all nodes as the anchor nodes (or search terms), and the results would indicate nodes that are deemed to be most relevant or similar based on all information in collection of electronic objects that were represented by the graph 200. The user may then refine the results by adding, removing, or modifying the anchor nodes based on his or her preferences as described above. In one embodiment, the user may not only select the anchor nodes as described above, but may also indicate that certain anchor nodes are more important to the user than other anchor nodes. The GUI 600 presented to the user in step 116 may be configured to allow the user to indicate the relative importance in various ways, such as an ordered list, a checkbox, etc.

The systems and methods for ranking electronic information described herein are believed to be advantageous over conventional search engines in a number of ways. For example, the systems and methods disclosed herein enable a user to dynamically interact with a large and disparate corpus of data to locate information regarding a topic of interest to the user. The systems and methods disclosed herein are applicable to multiplicity of datasets with a multiplicity of media types. The systems and methods disclosed herein are applicable to improving performance of computing systems in determining potentially more relevant results of interest to a user from both textual and non-textual corpus of electronic data such as publications, webpages, files, images, video, sensor data, user data, social network data etc. The systems and methods disclosed herein allow display of a user configurable number of potential results in a manner that exposes relevance of the results based upon one or more measures of “goodness” (or relevance) that can be determined by the user from a given set of ranked results. The systems and methods disclosed herein allow a user, by selecting or deselecting potential results, to interactively and dynamically direct the selection, ranking, scoring, and exposure of the results that are potentially of most interest to the user. The systems and methods disclosed herein allow a user, in an iterative manner, to navigate a large corpus of data more quickly to find relevant information in a large corpus of data and sequentially narrow a query via iterative anchoring and personalization. The systems and methods disclosed herein allow a user to specify the corpus of data that may be processed, ranked, and displayed as described above. For example, in one aspect the user may indicate or select, via one or more buttons provided in GUI 600, a user-selected corpus of data such as a set of files, documents, webpages, multimedia, which may constitute the source of the electronic objects described herein.

The systems and methods disclosed herein also differ from conventional search engines in a number of ways. For example, the systems and methods disclosed herein may allow more results to be displayed in accordance with their relevance than may be possible with typical listings of results produced using conventional search engines. The systems and methods disclosed herein allow for real-time or close to real-time ranking and scoring of the results, as opposed to conventional search engines where filtering the displayed set of result may reduce the set of displayed results rather than changing the ranking of the results themselves. The systems and methods disclosed herein allow ranked results to be displayed to the user in a number of dimensions, such as, for example, spatial dimensions, geometrical dimensions, etc. instead of the conventional static manner of displaying results utilized by conventional search engines.

FIG. 7 depicts a high-level block diagram of a computing apparatus 700 suitable for implementing various aspects of the disclosure (e.g., one or more steps of process 100). Although illustrated in a single block, in other embodiments the apparatus 600 may also be implemented using parallel and distributed architectures. Thus, for example, various steps such as those illustrated in the example of process 100 may be executed using apparatus 700 sequentially, in parallel, or in a different order based on particular implementations. Apparatus 700 includes a processor 702 (e.g., a central processing unit (“CPU”)), that is communicatively interconnected with various input/output devices 704 and a memory 706. Apparatus 700 may be implemented, for example, as a standalone computing device or server or as one or more blades in a blade chassis.

The processor 702 is any type of hardware processing unit such as a general purpose central processing unit (“CPU”) or a dedicated microprocessor such as an embedded microcontroller or a digital signal processor (“DSP”). The input/output devices 704 may be any peripheral device operating under the control of the processor 702 and configured to input data into or output data from the apparatus 700, such as, for example, network adapters, data ports, and various user interface devices such as a keyboard, a keypad, a mouse, or a display.

Memory 706 is any type of memory suitable for storing electronic information, such as, for example, transitory random access memory (RAM) or non-transitory memory such as read only memory (ROM), hard disk drive memory, compact disk drive memory, optical memory, etc. The memory 706 may include data and instructions which, upon execution by the processor 702, may configure or cause the apparatus 700 to perform or execute the functionality or aspects described hereinabove (e.g., one or more steps of process 100). In addition, apparatus 700 may also include other components typically found in computing systems, such as an operating system, queue managers, device drivers, or one or more network protocols that are stored in memory 706 and executed by the processor 702.

While a particular embodiment of apparatus 700 is illustrated in FIG. 7, various aspects of in accordance with the present disclosure may also be implemented using one or more application specific integrated circuits (ASICs), field programmable gate arrays (FPGAs), or any other combination of hardware or software. For example, data may be stored in various types of data structures (e.g., linked list) which may be accessed and manipulated by a programmable processor (e.g., CPU or FPGA) that is implemented using software, hardware, or combination thereof.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. A system for processing electronic information, the system comprising:
a processor configured to:
determine a set of unique features from a collection of electronic objects;
construct a graph in which each electronic object is represented as an object node and each unique feature is represented as a feature node and where each object node is interconnected by a weighted edge to at least one feature node;
construct a weighted adjacency matrix using the graph;
determine a vector to represent a set of anchor nodes in the graph; and,
compute scores for the object nodes and the feature nodes of the graph using the vector representing the set of anchor nodes and the weighted adjacency matrix.

2. The system of claim 1, wherein the processor is further configured to:
rank the object nodes and the feature nodes of the graph based on the computed scores.

3. The system of claim 1, wherein the processor is further configured to:
display the ranked object nodes and feature nodes of the graph on a display device.

4. The system of claim 3, wherein the processor is further configured to:
receive user input representing a selection of one or more of the displayed nodes;
update the vector representing the set of anchor nodes in the graph based on the selection of the one or more of the displayed nodes; and,
compute updated scores for the object nodes and the feature nodes of the graph using the updated vector and the weighted adjacency matrix.

5. The system of claim 4, wherein the processor is further configured to:
update the ranks of the object nodes and the feature nodes of the graph based on the updated scores; and,
update the display of the ranked object nodes and feature nodes on the display device based on the updated ranks.

6. The system of claim 1 wherein the processor is configured to:
compute the scores for the object nodes and the feature nodes of the graph by iteratively applying the vector representing the set of anchor nodes and the weighted adjacency matrix to a Personalized Page Rank algorithm.

7. The system of claim 6, wherein processor is configured to:
compute the scores for the object nodes and the feature nodes of the graph by aggregating scores resulting from each iteration of the Personalized Page Rank algorithm.

8. The system of claim 1 wherein the processor is further configured to:
determine the set of anchor nodes in the graph based on user input.

9. The system of claim 1 wherein the processor is further configured to:
determine the set of anchor nodes in the graph by selecting each object node and each feature node of the graph as an anchor node in the set of anchor nodes.

10. The system of claim 1, wherein processor is configured to:
determine at least one unique feature in the set of unique features to represent textual information in the collection of electronic objects.

11. The system of claim 1, wherein processor is configured to:
determine at least one unique feature in the set of unique features to represent non-textual information in the collection of electronic objects.

12. The system of claim 1, wherein processor is configured to:
apply a machine learning algorithm to the collection of electronic objects and determine at least one unique feature in the set of unique features using the machine learning algorithm.

13. A computer-implemented method for processing electronic information, the method comprising:
providing one or more executable instructions to a processor, the one or more executable instructions, when executed by the processor, configuring the processor for:
determining a set of unique features from a collection of electronic objects;
constructing a graph in which each electronic object is represented as an object node and each unique feature is represented as a feature node and where each object node is interconnected by a weighted edge to at least one feature node;
constructing a weighted adjacency matrix using the graph;
determining a vector to represent a set of anchor nodes in the graph; and,
computing scores for the object nodes and the feature nodes of the graph using the vector representing the set of anchor nodes and the weighted adjacency matrix.

14. The computer-implemented method of claim 13, wherein the one or more executable instructions further configured the processor for:
ranking the object nodes and the feature nodes of the graph based on the computed scores.

15. The computer-implemented method of claim 13, wherein the one or more executable instructions further configured the processor for:
displaying the ranked object nodes and feature nodes of the graph on a display device.

16. The computer-implemented method of claim 15, wherein the one or more executable instructions further configured the processor for:
receiving user input representing a selection of one or more of the displayed nodes;
updating the vector representing the set of anchor nodes in the graph based on the selection of the one or more of the displayed nodes; and,
computing updated scores for the object nodes and the feature nodes of the graph using the updated vector and the weighted adjacency matrix.

17. The computer-implemented method of claim 16, wherein the one or more executable instructions further configured the processor for:
updating the ranks of the object nodes and the feature nodes of the graph based on the updated scores; and,
updating the display of the ranked object nodes and feature nodes on the display device based on the updated ranks.

18. The computer-implemented method of claim 13, wherein the one or more executable instructions further configured the processor for:
computing the scores for the object nodes and the feature nodes of the graph by iteratively applying the vector representing the set of anchor nodes and the weighted adjacency matrix to a Personalized Page Rank algorithm.

19. The computer-implemented method of claim 18, wherein the one or more executable instructions further configured the processor for:
computing the scores for the object nodes and the feature nodes of the graph by aggregating scores resulting from each iteration of the Personalized Page Rank algorithm.

20. The computer-implemented method of claim 13, wherein the one or more executable instructions further configured the processor for:
determining the set of anchor nodes in the graph based on user input.

21. The computer-implemented method of claim 13, wherein the one or more executable instructions further configured the processor for:
determining the set of anchor nodes in the graph by selecting each object node and each feature node of the graph as an anchor node in the set of anchor nodes.

22. The computer-implemented method of claim 13, wherein the one or more executable instructions further configured the processor for:
determining at least one unique feature in the set of unique features to represent textual information in the collection of electronic objects.

23. The computer-implemented method of claim 13, wherein the one or more executable instructions further configured the processor for:
determining at least one unique feature in the set of unique features to represent non-textual information in the collection of electronic objects.

24. The computer-implemented method of claim 13, wherein the one or more executable instructions further configured the processor for:
applying a machine learning algorithm to the collection of electronic objects and determining at least one unique feature in the set of unique features using the machine learning algorithm.
